(19) United States
(12) Patent Application Publication
(10) Pub. No.: US 2014/0100496 A1
(43) Pub. Date: Apr. 10, 2014

(54) DEVICES AND METHODS FOR PERFORMING CPR WHILE STANDING UP

(71) Applicant: PHYSIO-CONTROL, INC., Redmond, WA (US)

(72) Inventors: Bethany Joyce Johnson, Snoqualmie, WA (US); John Carlton Daynes, Redmond, WA (US); Fred W. Chapman, Newcastle, WA (US); Robert P. Marx, Jr., Kent, WA (US); Gregory T. Kavounas, Bellevue, WA (US); Erik Carl Bernhard von Schenck, Lomma (SE)

(73) Assignee: PHYSIO-CONTROL, INC., Redmond, WA (US)

(21) Appl. No.: 13/970,215

(22) Filed: Aug. 19, 2013

Related U.S. Application Data
(60) Provisional application No. 61/711,633, filed on Oct. 9, 2012.

(51) Int. Cl. A61H 31/00

(52) U.S. Cl. CPC A61H 31/007; A61H 31/008
USPC 601/41

(57) ABSTRACT

In one embodiment, a manual CPR device, also known as a CPR derrick, includes a frame that is put close to a patient who is on the ground. The device also includes a piston that can be moved up and down, and is aligned to be over the patient's chest. The device also has an actuator that the rescuer can operate manually so as to move the piston up and down, which will deliver compressions to the patient's chest. A bottom stop prevents the compressions from being too deep. In some embodiments, proper dimensioning of the CPR derrick permits the rescuer to perform CPR chest compressions while standing up, i.e. without kneeling. The rescuer may be able to perform higher quality CPR, and for a longer time, giving more opportunity to a life-saving team to arrive in time.

### CROSS REFERENCE TO RELATED PATENT APPLICATIONS

This patent application claims priority from U.S. Provisional Patent Application Ser. No. 61/711,633, filed on Oct. 9, 2012, titled: “Manual Device to Assist CPR Chest Compressions while Standing Up”, the disclosure of which is hereby incorporated by reference for all purposes.

### BACKGROUND

Cardio-Pulmonary Resuscitation, also known as “CPR”, is often used to treat a patient whose heart has stopped beating. CPR includes delivering chest compressions and ventilations to the patient. CPR chest compressions are intended to cause the blood to continue circulating, so as to prevent damage to vital organs, such as the brain. Organizations such as the American Heart Association (AHA) have published guidelines about how the chest compressions should be performed, so as to be effective. The guidelines affect the compression depth, repetition rate, and so on.

CPR may have to be performed for a long time, before competent help arrives. However, rescuer fatigue often prevents CPR chest compressions from being performed correctly for a long time, at least in the traditional way. Indeed, the traditional way requires the rescuer to be on his knees, while the patient is supine on a surface that is usually the floor. After some time, the rescuer's knees will start to hurt. Moreover, to perform a good release after each compression, the rescuer often has to lift his torso by the waist, while the torso is in near horizontal position, which is also tiring.

When the compressions stop being performed correctly, such as due to the rescuer's fatigue, less blood reaches the patient's vital organs. When circulation degrades too much, CPR becomes merely ineffective, and the patient may die.

### BRIEF SUMMARY

The present description gives instances of CPR devices and methods, the use of which may help overcome problems and limitations of the prior art.

A manual CPR device is provided, which is also called a CPR derrick. In various embodiments, the device includes a frame that is put close to a patient who is on the ground. The device also includes a piston that can be moved up and down, and is aligned to be over the patient's chest. The device also has an actuator that the rescuer can operate manually so as to move the piston up and down, which will deliver compressions to the patient's chest. A bottom stop prevents the compressions from being too deep.

An advantage over the prior art is that, in some embodiments, a CPR derrick permits the rescuer to perform CPR chest compressions while standing up, in other words without kneeling. Standing up will be less taxing on the knees than traditional CPR, as will be appreciated by those who have been trained in traditional CPR. Moreover, in some embodiments the rescuer does not have to bend down very far, or lift his torso from a near horizontal position by using his waist, which will tire him even less. As such, the rescuer may be able to perform higher quality CPR, and for a longer time, giving more opportunity to a life-saving team to arrive in time.

Embodiments of the invention, especially when provided along with CPR training, may prove useful to trained first responders, and even firemen and Emergency Medical Services (EMS) personnel, if they want to perform CPR before defibrillation. Embodiments may also prove useful for people who are concerned about their ability to provide CPR of adequate quality, such as older people who may not have the strength & endurance to provide adequate compressions in the traditional way, and people of smaller stature who may lack the bodily weight to provide deep enough compressions to a life companion in the traditional way.

These and other features and advantages of this description will become more readily apparent from the following Detailed Description, which proceeds with reference to the drawings, in which:

### BRIEF DESCRIPTION OF THE DRAWINGS

FIG. 1 is a diagram of a resuscitation scene where a general embodiment is used.

FIG. 2 is a diagram of an embodiment where the frame has at least two legs.

FIG. 3 is a diagram of an embodiment where the actuator uses lever action.

FIG. 4 is a diagram of a resuscitation scene, where another embodiment is used.

FIG. 5 is a diagram of components of an embodiment that uses a spring.

FIG. 6 is a diagram of components of an embodiment where the actuator includes a foot pedal.

FIG. 7 is a diagram of components of an embodiment where the piston terminates in a suction cup for active decompression.

FIG. 8 is a flowchart for illustrating methods according to embodiments.

### DETAILED DESCRIPTION

As has been mentioned, the present description is about devices and methods for assisting a rescuer to perform CPR chest compressions. Embodiments are now described in more detail.

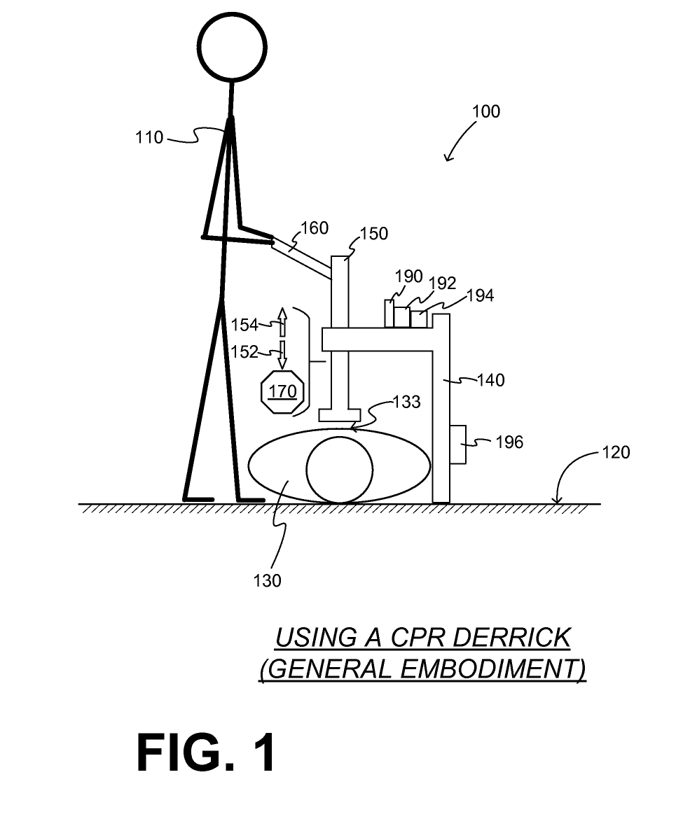

FIG. 1 is a diagram of a resuscitation scene where a general embodiment of the invention is used. Particular embodiments and implementations are described later in this document, and their features or variations could be added to the general embodiment of FIG. 1.

In FIG. 1, a patient 130 is supine, in other words lying face up, on a horizontal surface 120. Surface 120 can be the ground, a floor, and generally a surface that people stand on, and is generally flat. As such, surface 120 is generally where a person lies down, when they first need CPR. Surface 120 is also the reference for defining directions such as up and down, height, and so on, in this document.

A rescuer 110 is standing on surface 120, in order to deliver CPR chest compressions to patient 130. Rescuer 110 is using a device 100, which is made according to embodiments. Device 100 can also be called a manual CPR device and a CPR derrick. Device 100 is configured to enable rescuer 110 to administer manual CPR chest compressions to patient 130. As will be seen later in this document, some embodiments of device 100 extend partially under patient 130, which is why it can be said that patient 130 is supine at least in part on surface 120. Moreover, rescuer 110, or other rescuers, may also have to be concerned about delivering independently ventilation breaths to patient 130.

Device 100 includes a frame 140. Frame 140 is configured to be placed on horizontal surface 120, and proximately to patient 130. Different particular embodiments of frame 140 are described later in this document, and which further explain how, in some particular embodiments, frame 140 can be placed so that it stands upright on its own as shown in the general embodiment of FIG. 1. Frame 140 can be made of metal, hard plastic, or any other suitable material.

In some embodiments, device 100 also includes a restraint, which is not shown. The restraint can be inflexible or flexible such as a belt. The restraint is configured to constrain the possible movement of patient 130 with respect to frame 140, by tying the body of patient 130 to frame 140.

Device 100 also includes a piston 150, which is intended to deliver the CPR chest compressions to patient 130. More particularly, piston 150 is configured so that it can be brought over the chest 133 of patient 130, when frame 140 has been placed on horizontal surface 120 and proximately to patient 130. Piston 150 is coupled to frame 140 so that it is vertically movable down and up with respect to frame 140.

In many of the shown embodiments, the piston is shown as having a long vertical member, but that is wholly optional. Importantly, piston 150 has a first portion that will compress the patient chest. In many of the shown embodiments, piston 150 also optionally includes a second elongate portion that will guide the first portion, enable measuring of position, and so on. In those cases, the first portion is also called the bottom end. Plus, the elongate portion will also help the rescuer even more in visualizing the vector of the impending downward movement towards the patient chest. It will be appreciated, however, that piston 150 of a CPR derrick does not need its elongated top portion. Indeed, the first portion could be guided by a side member moving vertically in part, and so on. Piston 150 is made from suitable materials, such as metal or hard plastic.

Device 100 moreover includes an actuator 160. Actuator 160 can be implemented in any number of ways, such as being coupled to piston 150, frame 140, or both.

Actuator 160 can be configured to be operated manually by rescuer 110. Manual operation means that actuator 160 is not a switch that is used to turn on a machine, which in turn would do the work of compressing. Rather, rescuer 110 manually exerts himself or herself to operate actuator 160, and the manual operation imparts kinetic energy to actuator 160. Actuator 160 is coupled with piston 150 such that at least some of the kinetic energy is received by piston 150. In turn, the kinetic energy is expended by piston 150, as piston 150 performs repeating cycles of down motions in direction 152, and up motions in direction 154. For the repeating cycles, up motions 154 follow down motions 152, and vice versa. The down motions compress chest 133 of patient 130, and the up motions release chest 133 from the compression of the down motions, thus delivering the CPR chest compressions. Actuator 160 can be made from metal, hard plastic, or other suitable materials. When intended to be hand-operated, it may be covered by a suitable material for better grasping by hand.

As such, operating actuator 160 of device 100 requires rescuer to physically exert himself, so that he delivers kinetic energy. Compared to performing traditional CPR, however, exertion in operating actuator 160 does not tire rescuer 110 as much, due to the design of device 100. As a result of the lesser fatigue, rescuer 110 can perform compressions correctly, and for a longer time, which can make a life-or-death difference for patient 130, given how long a rushed life-saving team may need to arrive.

The available travel of piston 150 is defined as the vertical distance that it can span, while being moved up and down for the chest compressions. The travel has to extend downwards long enough to reach down to chest 133 of patient 130, and then even lower so as to compress the chest. The rest position of piston 150 is defined as where piston 150 stops, if device 100 is upright and piston 150 is released while there is no patient underneath. In some embodiments, the rest position is surface 120.

Device 100 additionally includes a bottom stop 170, which is shown only generally in FIG. 1. Bottom stop 170 is coupled so as to prevent the down motion 152 of piston 150 from exceeding a specific bottom point of the available travel, in other words, to limit the downward point of the available travel.

In some embodiments, bottom stop 170 is adjustable. The bottom point of the available travel is adjustable accordingly. The adjustment can be set so as to prevent the CPR chest compressions from exceeding a maximum depth, beyond which the delivery of CPR to the patient 130 would be ineffective. The maximum desired depth can be as specified by appropriate medical guidelines, such as the American Heart Association (AHA) for the USA. The AHA guidelines for an adult male stipulate that the depth of the compressions should reach 2-2.5 in. (5-6 cm).

In some embodiments, a pneumatic cylinder (not shown) is further coupled between frame 140 and piston 150. The pneumatic cylinder can slow down the speed at which piston 150 reaches the bottom point of its travel, presumably compressing the patient's chest, so that compressions would not impact chest 133 too suddenly. In fact, in some embodiments, the end of the available motion of such a pneumatic cylinder can also serve as bottom stop 170.

In addition, a top stop (not shown in FIG. 1) could be provided to prevent the up motion of piston 150 from exceeding a vertical travel in the upward direction. The top stop is preferably set so that full release of the chest is accomplished. The available travel then can be defined as being between bottom stop 170 and the top stop, where provided.

In some embodiments, the frame is not unitary, but has parts that can be moved with respect to each other. One possibility is that the frame can be adjusted so that piston 150 is vertically adjustable prior to operation. As such, piston 150 can be brought to contact chest 133 as a rest position, before the compressions start. Adjustability can be implemented in any number of ways. For example, a screw or handle can be un-tightened to release the moving frame parts, and then re-tightened to engage the frame parts at different locations.

Taking a step back in FIG. 1, an advantage of the invention can now be appreciated better. In many embodiments, rescuer 110 can operate actuator 160 of device 100 manually while he is standing up, not kneeling, for a long time. Moreover, he does not need to be bending down for the full duration of these cycles, or be lifting the weight of his torso from the waist.

The exact dynamics for operating actuator 160 will be determined from how the actual embodiment will be implemented. In many embodiments, down motion 152 can be performed by rescuer 110 pushing actuator 160 from the shoulders down, while standing up. In others, down motion 152 can be performed by rescuer 110 pulling actuator 160 from the shoulders down. FIG. 1 could have been drawn as the latter by showing piston 150 taller, actuator 160 higher, and rescuer 110 reaching up for it.

A person skilled in the art will be able to design a device according to embodiments, so that such operation will be enabled. For example, in some particular embodiments, device 100 could be dimensioned such that, if rescuer 110 is 5.5 ft. (168 cm) tall, and the patient's chest is 12 in. (30 cm) above horizontal surface 120 while not compressed by piston 150, rescuer 110 can operate actuator 160 for the full duration of at least three cycles while standing up and without bending down. In such embodiments, actuator 160 at full compression depth could be, for example, at least 24 in. (60 cm) above horizontal surface 120. If frame 140 has moving parts, the same effect can be designed for people of different heights.

In some embodiments, the height of actuator 160 is adjustable while piston 150 is at the rest position. Accordingly, a rescuer 110 or a prospective rescuer can adjust the height of actuator 160 to be at the height that they want, so they can operate it correctly and with minimum fatigue for a long time. Adjustability can be accomplished in any number of ways. For example, a screw can be turned loose to permit actuator 160 to be shifted or rotated with respect to piston 150 or frame 140, and then tightened again when actuator 160 is at the desired position. The adjustment can be made before any rescuing using a CPR mannequin, along with CPR feedback as is described later in this document. In some instances the adjustment can be so that actuator 160 can be operated with no bending down, while in others there may be some bending down so that the weight of the rescuer's body is also leveraged.

A number of embodiments are possible. In some of these embodiments, frame 140 includes a groove, and piston 150 is vertically movable within the groove. Having such a groove, though, is not necessary for practicing the invention. Such is suggested in general FIG. 1 only to illustrate that down motions 152 and up motions 154 of piston 150 are defined in terms of frame 140.

Embodiments can also include additional features. Examples are now described.

Device 100 optionally also includes a user interface 190. User interface 190 can be configured to produce one or more human-perceptible indications, for rescuer 110 to adjust the operation of actuator 160. User interface 190 can include a display or a light, for the indications to be visual, a speaker for the indications to be auditory, a vibrating mechanism for the indications to be tactile, and so on. User interface 190 can also have implements for a user to enter data, such as a keypad, a keyboard, a touchscreen, and so on.

By way of example, user interface 190 can be coupled to frame 140, or even to actuator 160. User interface 190 can be powered from a battery, or a wall outlet. In some cases, the user interface can ultimately be powered from the motion of rescuer 110. Indeed, rescuer 110 can impart kinetic energy in actuator 160, and user interface 190 can receive and convert some of it. This embodiment permits having a manual CPR device with indefinite shelf life that needs no consumable elements that need to be replaced periodically, such as a battery. It is not preferred, however, as it is desired to not divert any of the rescuer's effort to purposes other than chest compressions.

In some embodiments, the human-perceptible indications are preset. For example, user interface 190 can include a metronome with auditory or visual indications that suggest a rate of compressions, and which are the same regardless of how well rescuer 110 is performing. Rescuer 110 may adjust the operation by synchronizing to such indications.

In other embodiments, the human-perceptible indications provide feedback for CPR quality. Device 100 optionally also includes a position detection mechanism (not shown), which can be configured to detect a position of piston 150 relative to frame 140. This can be performed in many ways, many of which might not be visible from the outside of the assembled final device 100. One such way is a rack-and-pinion mechanism, whose turning would measure the displacement of piston 150 along its travel. Another such way is to embed a sensor in frame 140, and items that the sensor would sense in piston 150. These items can be of optical nature, such as mirrors, for an optical sensor, RFID tags for a sensor that is an RFID reader/writer, and so on. Device 100 optionally also includes a CPR metric detection mechanism 192. CPR metric detection mechanism 192 can be configured to compute a metric responsive to the position detected by position detection mechanism, and would generally be implemented electronically. Examples of such a metric would be compression depth, rate, and perhaps even duty cycle. In such cases, then, the human-perceptible indication generated by user interface 190 can represent the value of the computed metric. Additionally, the computed value can be shown together with a desired value for the metric. In some embodiments, the indication can include an alarm, if the value of the computed metric differs from a desired value for the metric by more than a threshold.

Device 100 optionally includes a memory 194. Memory 194 can be used for storing data collected by various mechanisms of device 100, data input by rescuer 110 or his team members via user interface 190, and so on. The contents of the memory can be used afterwards for event analysis, for studies, etc.

For operating memory 194, various embodiments of user interface 190, it is often practical to additionally include a processor and software. A person skilled in the art will be able to implement such, in view of the present description.

In some embodiments, device 100 includes an output mechanism (not shown), which is intended to communicate the detected position to another nearby device (not shown). The other device can be a defibrillator, a monitor, a smartphone, and so on. Communicating can be wireless or wired. In turn, the other device is preferably able to communicate to rescuer 110 what it receives, plus feedback and other guidance. The other device might further record the received data for later analysis and evaluation, and so on. These embodiments can be useful where interface 190 and/or memory 194 are not provided.

Device 100 optionally further includes a defibrillator 196. Defibrillator 196 can be used on patient 130 if there is a need. In some instances, CPR compressions using device 100 after a Ventricular Fibrillation or Ventricular Tachycardia episode might improve the chance that patient 130 will have, that defibrillation will restore their normal sinus rhythm.

It should be remembered that FIG. 1 was a general embodiment. Additional embodiments, which are described below, could also include features described above.

In some embodiments, the frame has at least two legs. Advantageously, the frame can be configured to be placed proximately to the patient by straddling the patient with the two legs of the frame. This way the device is ready for service.

While the legs add stability, they also add volume to the manual CPR device. In some of these embodiments, at least one of the legs is foldable with respect to a remainder of the frame, so as to occupy less volume while in storage. Moreover, adding the legs adds weight to the device. Some embodiments are provided with one or more wheels for easier transport. In particular, the whole manual CPR device can be configured to be rolled on the one or more wheels, for being brought close to the patient.

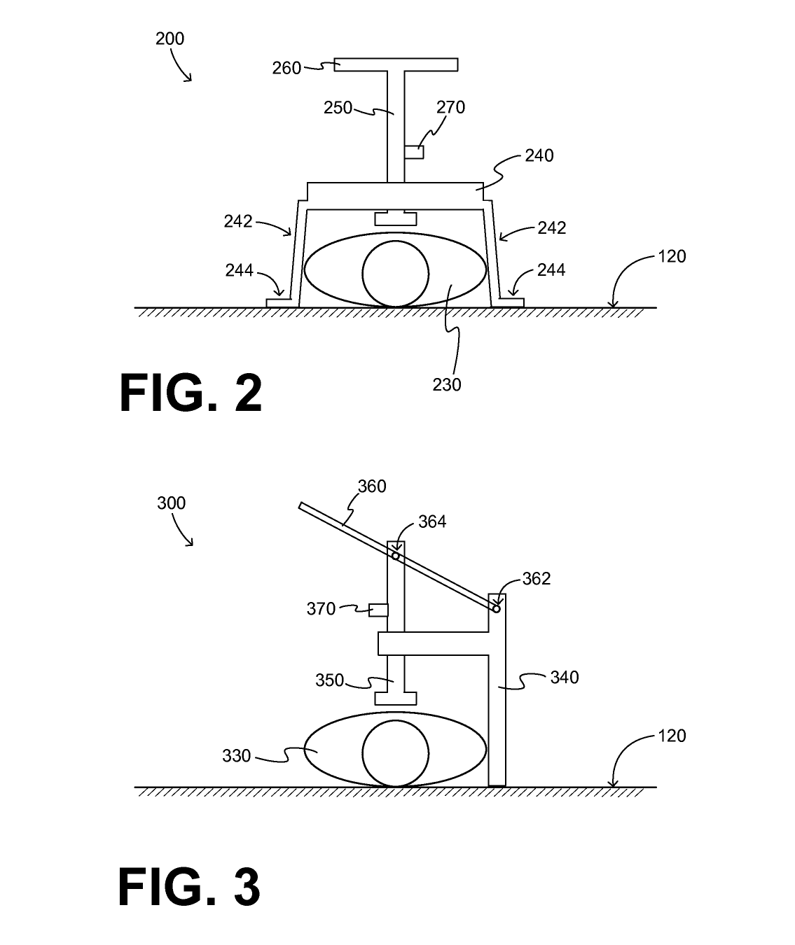

FIG. 2 is a diagram of an embodiment 200. Embodiment 200 includes a frame 240 that has at least two legs 242. For further stability, legs 242 could be elongate, extending vertically into the plane of FIG. 2. Or, additional legs could be provided, behind legs 242.

Frame 240 can be placed so that it straddles patient 230 with legs 242. In some embodiments, the legs are adjustable laterally with respect to frame 240, so as to set the spacing between them at a desirable value. Setting can be done in anticipation of patients of different sizes. Legs 242 would be set closer to each other, for example, if the use would be for a high school student, than for the home of a known expected adult patient of large size. Moreover, the adjustment can be done in anticipation of the expected rescuer: in a high school the expected rescuer may be a Physical Education teacher, while at a home it could be the spouse of an expected patient.

Embodiment 200 also includes a piston 250, and an actuator 260 that is a handle. The handle can be moved up and down, which causes piston 250 to perform the up motions and the down motions. This is an example of an actuator that is retained substantially horizontal with respect to horizontal surface 120 for its manual operation through many of the cycles.

The embodiment of FIG. 2 is also an example of where the actuator is operated by being moved in two substantially opposite directions, at the same frequency as the up and down motions. Other embodiments are also possible. For example, a second actuator can be further provided, which can be moved in unison or not with the first. For another example, a wheel or flywheel could be provided with gear. The actuator can be one or more handles or pedals for causing the wheel to spin, and the spinning wheel in turn causes, via the gear, the piston to perform the down and up motions.

Embodiment 200 further includes a bottom stop 270, which limits the travel, and thus also the down motions, that piston 250 can perform. Limiting is when bottom stop 270 bumps into frame 240 in this embodiment as piston 250 is being moved downwards.

Some embodiments further include a base coupled to the frame, which can be implemented in any number of ways. The manual CPR device can be configured to be placed with the base on the horizontal surface, as the frame is placed near the patient. In some of these embodiments, the base can help the frame be placed upright, with the manual CPR device ready for use.

In some of the embodiments, the base includes a footplate. The footplate can be configured such that the rescuer can stand on it, when the base is placed on the horizontal surface. As an example, in FIG. 2 embodiment 200 includes a base made from two footplates 244 attached to respective legs 242. A rescuer using device 200 can stand on footplates 244, either completely or partially. This way the rescuer may acquire incrementally better control of the entire manual CPR device.

The base can be rigidly coupled to the frame. Alternately, the base can be detachable from, or foldable with respect to the frame, again for considerations of optimizing the balance between considerations such as ease of use, minimization of weight, and minimization of volume for storing.

In the embodiment of FIG. 2, the possible travel of handle 260 is equal to the travel of piston 250. In other embodiments, the piston is coupled with the frame such that the down motion and/or the up motion are performed by lever action of the actuator. An example is now described.

FIG. 3 is a diagram of an embodiment 300, where the actuator uses lever action. More particularly, embodiment 300 includes a frame 340 and a piston 350 for performing chest compressions on patient 330. A bottom stop 370 limits the vertical travel of piston 350.

Embodiment 300 also includes an actuator 360 that is a handle. The handle can be moved up and down, to cause piston 350 to perform the up motions and the down motions. Handle 360 is movably coupled with piston 350 via a joint 364. Handle 360 rotates around a joint 362 in frame 340, and therefore operates as a lever for piston 350, providing mechanical advantage. Because of the mechanical advantage, handle 360 will have to be moved farther than handle 260, and with the same frequency, but with less force, in order to achieve the same profile of chest compressions.

In some of the embodiments, at least a portion of the base can be placed under the patient. An example is now described.

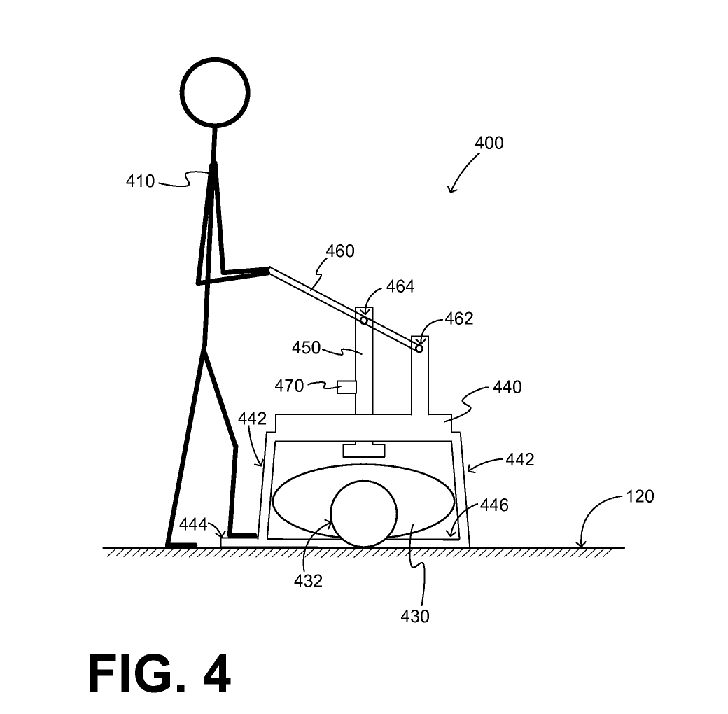

FIG. 4 is a diagram of a resuscitation scene. A rescuer 410 is performing chest compressions on a patient 430 by using a device 400, which is made according to embodiments.

Device 400 includes a frame 440 that has legs 442. In addition, a base is provided that has a portion 446 that is placed under patient 430, and joins legs 442 for better structural stability. Portion 446 is not under the entire body of patient 430; indeed, the head 432 of patient 430 may rest on horizontal surface 120. In addition, the base includes a footplate 444 for rescuer 410 to step on, from one side.

Device 400 also includes a piston 450 for performing chest compressions on patient 430. A bottom stop 470 limits the downwards available vertical travel of piston 450, by bumping into frame 440.

Device 400 moreover includes an actuator 460 that is a handle. The handle is moved up and down, to cause piston 450 to perform the up motions and the down motions. Handle 460 is movably coupled with piston 450 via a joint 464. Handle 460 rotates around a joint 462 in frame 440, and therefore operates as a lever, similarly with FIG. 3.

A manual CPR device, according to some embodiments, further includes a spring. The spring can be coupled to assist the down motion or the up motion, at least in part. An example is now described.

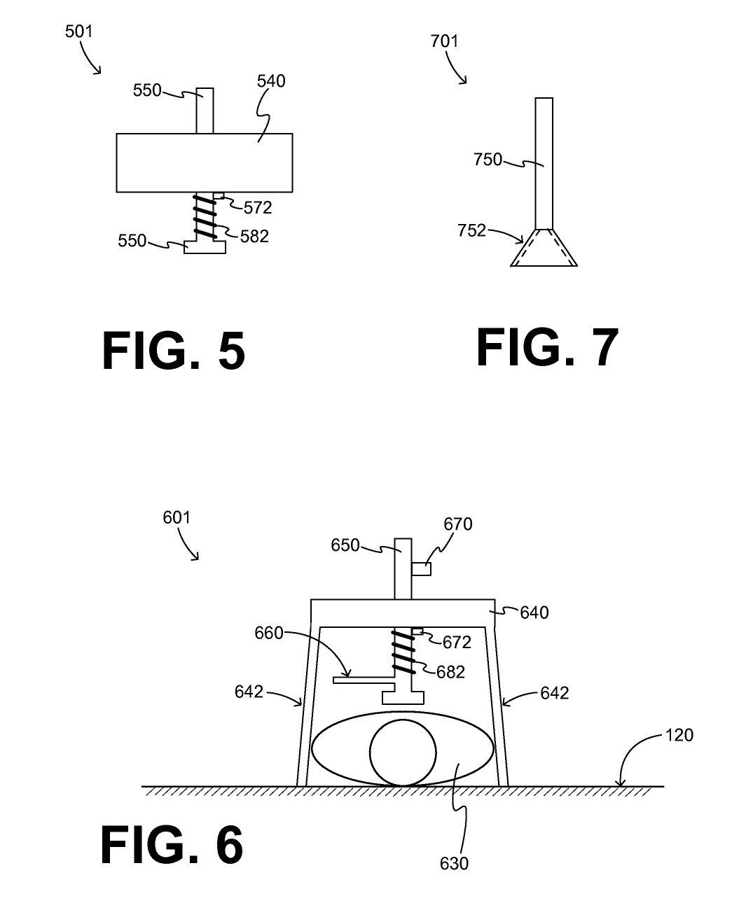

FIG. 5 is a diagram of only components 501 of a full manual CPR device, which are made according to an embodiment that uses a spring. Components 501 include a frame 540, and a piston 550 that is moveable with respect to frame 540. A spring 582 is coupled between frame 540 and piston 580. When provided, spring 582 is also preferably covered by a shield, so that it will not catch clothes of the rescuer. The shield can be in the shape of a sleeve, placed around spring 582, and be made from metal, plastic, or other suitable material.

Spring 582 biases piston 550 upwards. Accordingly, the rest position of piston 582 is not the bottom of its available travel. When piston 550 is caused to move downwards for a compression, spring 582 decelerates piston 550, which is a somewhat similar effect to the resistance provided by the above-mentioned pneumatic cylinder, when provided.

Accordingly, the rest position of piston 582 is determined by the contraction of spring 582, and also a top stop 572, if the latter is provided. Top stop 572 in this example is attached to piston 550 and travels with it. It prevents piston 550 from moving upwards beyond an up limit, by bumping into frame 540.

The spring can be added in different ways. In some, the bias of the spring will favor moving the piston in one of the directions at the expense of disfavoring the other. In the case of FIG. 5, spring 582 is coupled such that piston 550 becomes harder to push down and easier to pull up. The opposite could also be implemented, but the arrangement of FIG. 5 is preferred. Indeed, for the down motion, spring 82 will usefully slow down piston 550 at the end of its travel, while the rescuer may be finding it easier to leverage his weight. For the motion up, however, the rescuer needs to pull up so as to effectively cause piston 550 to be lifted, and the assistance by spring 582 will be welcome in pulling up. This lifting, which is also known as recoil, is often neglected in CPR compressions as rescuers become tired, but it is important so as to achieve decompression of the patient's chest.

It will be recognized that the upward bias of spring 582 is implemented by having spring 582 resist its own extension. In such embodiments, spring 582, when extended at its maximum, could also act as the bottom stop. Equivalently, a spring could be coupled between frame 540 and piston 550, and provide upward bias by resisting its own compression. Such as spring could be placed over frame 540, and be surrounding and attached to the top portion of piston 550. In such embodiments, the spring, when compressed at its maximum, could also act as the bottom stop.

It will be recognized that a spring like spring 582 or its equivalent could be added to the embodiments of FIG. 2, FIG. 3, and FIG. 4. Furthermore, in the examples of FIG. 2, FIG. 3, FIG. 4, the actuator is moved by hand. There are also other embodiments, and an example is now described.

FIG. 6 is a diagram of only components 601 of a full manual CPR device, which are made according to an embodiment where a foot pedal is used. Components 601 include a frame 640 that has legs 642. A piston 650 can be moved with respect to frame 640 to deliver chest compressions to a patient 630, which are only as deep as is permitted by a bottom stop 670.

A spring 682 biases piston 650 upwards, thus providing recoil from the down motion of piston 650. The upwards biasing is only as far as is permitted by top stop 672. As such, bottom stop 670 and top stop 672 define the vertical travel of piston 650.

Actuator 660 includes a foot pedal, which is moveable by the rescuer's foot. The down motions of piston 650 are accomplished by the rescuer stepping on pedal 660 and adding weight to it, while the up motions of piston 650 are accomplished by the rescuer removing weight from pedal 660, and even stepping off of it. Frame 640 preferably includes also a handle (not shown) for the rescuer, so that they do not lose their balance while repeatedly stepping on and off pedal 660.

In some embodiments, the device further includes a suction cup. The piston has a bottom end, and the suction cup is coupled to the bottom end. Accordingly, the up motion of the piston performs active decompression on the patient chest, which improves the blood circulation effectuated by the CPR compressions. Active decompression means not only releasing the chest when the piston is on the way up, but actively pulling up the chest, which further improves on the circulation provided by the compressions. An example is now described.

FIG. 7 is a diagram of components 701 made according to embodiments. Components 701 include a piston 750, which is elongate. At a bottom end of piston 750 is a suction cup, which is intended to compress the patient's chest, create a vacuum, and then pull up the chest on the way up. Components 701 can be applied to any embodiment of the invention that uses a piston.

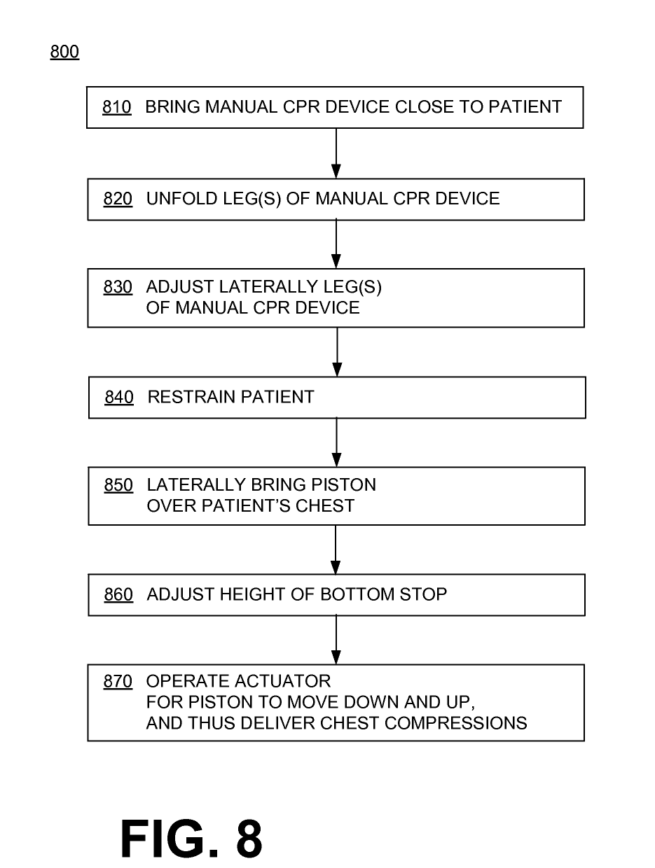

FIG. 8 shows a flowchart 800 for describing methods according to embodiments. The methods are for a rescuer to perform manual CPR chest compressions on a patient, when the patient is supine at least in part on a horizontal surface. These methods may be practiced using embodiments of a manual CPR device, which has at least a frame, a piston, an actuator and a bottom stop, such as described above.

According to an operation 810, a manual CPR device is brought close to the patient. In some embodiments, the manual CPR device also includes one or more wheels. In those embodiments, the device can be brought close to the patient by being rolled on the one or more wheels.

In some embodiments, the frame of the manual CPR device includes at least two legs. According to an optional operation 820, one or more of the legs is unfolded with respect to the remainder of the frame. In some embodiments, when the legs are unfolded, the frame can straddle the patient. According to another optional operation 830, the legs can be adjusted laterally with respect to the frame, so as to set the spacing between the two legs. This can be so that, while both the legs will be touching the ground, they are as close as possible for the comfort of the rescuer who may also be straddling the patient for operating the manual CPR device.

According to an optional next operation 840, the patient is restrained, for example by being tied to the frame using restraints. Restraining is so as to constrain a possible movement of the patient with respect to the frame.

According to a next operation 850, the piston is brought to be over a chest of the patient. This is a lateral movement for vertically aligning the piston over the chest of the patient, which will ensure that the subsequent downward movement of the piston will compress the chest at a point that is effective for CPR. This lateral movement is not necessarily a separate operation in embodiments of the manual CPR device where a base is included. In fact, the base need not be flat, but can be shaped so as to receive the patient in a way that already aligns the centerline of the chest with the piston.

According to an optional next operation 860, the bottom stop is adjusted. Adjusting is so as to limit the downward travel of the piston, and to ensure that the compressions will be as deep as needed for CPR, but not deeper.

According to an optional next operation 870, the actuator is operated manually by a rescuer, while the rescuer is standing on the horizontal surface. Operating the actuator imparts kinetic energy to it, and some of the kinetic energy is received and expended by the piston, as the piston performs cycles of down motions followed by up motions. The down motions compress the patient's chest, while the up motions release the chest from the compression of the down motions. The down motions of the piston are prevented from exceeding a vertical travel by the bottom stop.

In some embodiments, the actuator includes a handle that is manually operated by the rescuer's hand. In others, the actuator includes a foot pedal that is manually operated by the rescuer's foot. In some embodiments, the manual CPR device further includes a spring, and the down or the up motion is assisted by the spring.

In the above, the order of operations is not constrained to what is shown, and different orders may be possible according to different embodiments. In addition, in certain embodiments, new operations may be added, or individual operations may be modified or deleted.

In the above description of exemplary implementations, for purposes of explanation, specific numbers, materials configurations, and other details are set forth in order to better explain the present invention, as claimed. However, it will be apparent to one skilled in the art that the claimed invention may be practiced using different details than the exemplary ones described herein. In other instances, well-known features are omitted or simplified to clarify the description of the exemplary implementations.

The inventors intend the described exemplary implementations to be primarily examples. The inventor does not intend these exemplary implementations to limit the scope of the appended claims. Rather, the inventor has contemplated that the claimed invention might also be embodied and implemented in other ways, in conjunction with other present or future technologies.

Moreover, the word “exemplary” is used herein to mean serving as an example, instance, or illustration. Any aspect or design described herein as exemplary is not necessarily to be construed as preferred or advantageous over other aspects or designs. Rather, use of the word “exemplary” is intended to present concepts and techniques in a concrete fashion. The term “technology,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

Other embodiments include combinations and sub-combinations of features described herein, including for example, embodiments that are equivalent to: providing or applying a feature in a different order than in a described embodiment, extracting an individual feature from one embodiment and inserting such feature into another embodiment; removing one or more features from an embodiment; or both removing a feature from an embodiment and adding a feature extracted from another embodiment, while providing the advantages of the features incorporated in such combinations and sub-combinations.

The following claims define certain combinations and subcombinations of elements, features and steps or operations, which are regarded as novel and non-obvious. Additional claims for other such combinations and subcombinations may be presented in this or a related document.

In the claims appended herein, the inventor invokes 35 U.S.C. §112, paragraph 6 only when the words “means for” or “steps for” are used in the claim. If such words are not used in a claim, then the inventor does not intend for the claim to be construed to cover the corresponding structure, material, or acts described herein (and equivalents thereof) in accordance with 35 U.S.C. §112, paragraph 6.

What is claimed is:

1. A device configured to enable a rescuer standing on a horizontal surface to administer manually CPR chest compressions to a patient supine at least in part on the horizontal surface, the device comprising:
a frame configured to be placed on the horizontal surface proximately to the patient;
a piston configured so that it can be brought over a chest of the patient when the frame has been placed on the horizontal surface proximately to the patient, the piston coupled to the frame so that it is vertically movable down and up with respect to the frame within an available travel;
an actuator configured to be operated manually by the rescuer so as to impart kinetic energy to the actuator, the actuator being coupled with the piston such that some of the kinetic energy is received and expended by the piston performing, with respect to the frame, multiple cycles of down motions followed by up motions, the down motions compressing the patient's chest and the up motions releasing the chest from the compression of the down motions; and
a bottom stop coupled so as to prevent the down motions of the piston from exceeding a bottom point of the available travel.

2. The device of claim 1, further comprising:
a restraint configured to constrain a possible movement of the patient with respect to the frame.

3. The device of claim 1, in which
the bottom stop is adjustable so as to adjust the bottom point of the available travel.

4. The device of claim 1, in which
the frame includes frame parts that can be moved with respect to each other.

5. The device of claim 1, in which
a pneumatic cylinder is further coupled between the frame and the piston.

6. The device of claim 1, in which
the device is dimensioned such that, if the rescuer is 5.5 ft. (168 cm) tall, and the patient's chest is 12 in. (30 cm) above the horizontal surface while not compressed by the piston, the rescuer can operate the actuator for the full duration of the three cycles while standing up and without bending down.

7. The device of claim 1, further comprising:
a user interface configured to produce a human-perceptible indication for the rescuer to adjust the operation of the actuator.

8. The device of claim 7, in which
the user interface includes one of a display, a light, a speaker, and a vibrating mechanism.

9. The device of claim 7, in which
the user interface is powered from energy received in the actuator by its manual operation.

10. The device of claim 7, in which
the indication is preset.

11. The device of claim 7, further comprising:
a position detection mechanism configured to detect a position of the piston relative to the frame; and
a CPR metric detection mechanism configured to compute a metric responsive to the detected position, and
in which the indication includes an alarm, if the value of the computed metric differs from a desired value for the metric by more than a threshold.

12. The device of claim 7, further comprising:
a position detection mechanism configured to detect a position of the piston relative to the frame; and
a CPR metric detection mechanism configured to compute a metric responsive to the detected position, and
in which the indication represents a value of the computed metric.

13. The device of claim 12, in which
the value of the computed metric is shown together with a desired value for the metric.

14. The device of claim 1, further comprising:
a memory.

15. The device of claim 1, further comprising:
a defibrillator.

16. The device of claim 1, further comprising:
a position detection mechanism configured to detect a position of the piston relative to the frame; and
an output mechanism configured to communicate the detected position to another device.

17. The device of claim 1, in which
the frame includes a groove, and the piston is vertically movable within the groove.

18. The device of claim 1, in which
the frame has at least two legs.

19. The device of claim 18, in which
the frame is configured to be placed proximately to the patient by straddling the patient with the two legs.

20. The device of claim 18, in which
at least one of the legs is foldable with respect to a remainder of the frame.

21. The device of claim 18, in which
the legs are adjustable laterally with respect to the frame, so as to set a spacing between them.

22. The device of claim 1, further comprising:
a wheel, and
in which the device is configured to be rolled on the wheel for being brought to be placed proximately to the patient.

23. The device of claim 1, in which
the actuator is a handle.

24. The device of claim 1, in which
the actuator is a handle that is retained substantially horizontal with respect to the horizontal surface for its manual operation through many of the cycles.

25. The device of claim 1, further comprising:
a base coupled to the frame.

26. The device of claim 25, in which
the base includes a footplate configured such that the rescuer can stand on it when the base is placed on the horizontal surface.

27. The device of claim 25, in which
a portion of the base can be placed under the patient.

28. The device of claim 25, in which
the base is rigidly coupled to the frame.

29. The device of claim 25, in which
the base is detachably coupled to the frame.

30. The device of claim 25, in which
the base is foldably coupled to the frame.

31. The device of claim 1, in which
the piston is coupled with the frame such that one of the down motion and the up motion is performed by lever action of the actuator.

32. The device of claim 1, further comprising:
a spring coupled to assist of one of the down motion and the up motion, at least in part.

33. The device of claim 32, further comprising:
a shield coupled around the spring.

34. The device of claim 1, in which
the bottom stop is implemented by a spring.

35. The device of claim 1, in which
the actuator includes a foot pedal, which is moveable by the rescuer's foot.

36. The device of claim 1,
in which the piston has a bottom end, and
further comprising: a suction cup coupled to the bottom end of the piston, so that the up motion of the piston performs active decompression on the patient chest.

37. A method for a rescuer to perform manual CPR chest compressions on a patient supine at least in part on a horizontal surface, the method comprising:
bringing close to the patient a manual CPR device that has a frame, a piston, an actuator and a bottom stop;
bringing the piston to be over the chest of the patient; and
while standing on the surface, manually operating the actuator so as to impart kinetic energy to it, some of the kinetic energy received and expended by the piston performing, with respect to the frame, at least three cycles of down motions followed by up motions within an available travel, the down motions compressing the patient's chest and the up motions releasing the chest from the compression of the down motions, the down motions of the piston prevented from exceeding a bottom point of the available travel by the bottom stop.

38. The method of claim 37, in which
the device also includes at least one wheel, and
the device is brought close to the patient by being rolled on the wheel.

39. The method of claim 37, in which
the frame has at least two legs, and
further comprising: unfolding one of the legs with respect to a remainder of the frame.

40. The method of claim 37, in which
the frame has at least two legs, and
further comprising: adjusting the legs laterally with respect to the frame, so as to set a spacing between the two legs.

41. The method of claim 37, further comprising:
restraining the patient so as to constrain a possible movement of the patient with respect to the frame prior to the manual operation of the actuator.

42. The method of claim 37, further comprising:
adjusting the bottom stop so as to adjust the bottom point of the available travel.

43. The method of claim 37, in which
the actuator includes a handle that is manually operated by the rescuer's hand.

44. The method of claim 37, in which
the actuator includes a foot pedal that is manually operated by the rescuer's foot.

45. The method of claim 37, in which
the manual CPR device further includes a spring, and
one of the down motion and the up motion is assisted by the spring.
